(19) United States
(12) Patent Application Publication
(10) Pub. No.: US 2021/0298294 A1
(43) Pub. Date: Sep. 30, 2021

(54) COUGH PATCH WITH GERMICIDAL AND/OR ANTIMICROBIAL PROPERTIES

(71) Applicant: Cheryl JM Freitag, Mankato, MN (US)

(72) Inventor: Cheryl JM Freitag, Mankato, MN (US)

(21) Appl. No.: 17/213,521

(22) Filed: Mar. 26, 2021

Related U.S. Application Data
(60) Provisional application No. 63/000,925, filed on Mar. 27, 2020.

(51) Int. Cl. A01N 25/34; A01N 59/20; A01N 59/16

(52) U.S. Cl. CPC A01N 25/34; A01N 59/16; A01N 59/20

(57) ABSTRACT

A germicidal cough patch receives one or more coughs. The patch includes a body and a tab coupled to the body. The body and tab both extend substantially in a body plane. The body has a first face and a second face opposite the first face. One or more germicidal agents are at the first face, and one or more coupling mechanisms are at the second face.

### CROSS-RELATED TO RELATED APPLICATION

This application claims the benefit of U.S. Provisional Application No. 63/000,925, filed Mar. 27, 2020.

### BACKGROUND

Germs are often spread when people cough or sneeze into the air. Known methods for stopping the spread of germs include covering the mouth and nose when coughing or sneezing. However, germs may still be spread when people cough or sneeze into their hands, particularly when their hands are not washed afterwards. To reduce the spread of germs, some people may choose to cough or sneeze into their arm or elbow. However, this may still leave germs on the person's clothing and/or skin.

### SUMMARY

Examples described herein facilitate killing germs and/or pathogens to mitigate contamination of a person's clothing and/or skin. In one aspect, a patch is provided for use in receiving one or more coughs. The patch includes a body and a tab coupled to the body. The body and tab both extend substantially in a body plane. The body has a first face and a second face opposite the first face. One or more germicidal agents are at the first face, and one or more coupling mechanisms are at the second face.

In another aspect, a system is provided for use in receiving one or more coughs. The system includes a body and a tab coupled to the body. The body and tab both extend substantially in a body plane. The body has one or more germicidal agents at a first face and one or more coupling mechanisms at a second face opposite the first face.

In yet another aspect, a method is provided for preventing spread of germs from coughing. The method includes identifying an area for receiving one or more coughs, and applying a patch to the area. The patch includes a body and a tab coupled to the body. The body and tab both extend substantially in a body plane. The body has one or more germicidal agents at a first face and one or more coupling mechanisms at a second face opposite the first face.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWING

The present disclosure will be best understood by reference to the following Detailed Description when read in conjunction with the accompanying drawing, wherein:

FIG. 1 shows a plan view of an example cough patch; and

FIG. 2 shows a cross-sectional view of the cough patch shown in FIG. 1.

FIG. 3 shows a flowchart of an example method for preventing spread of germs from coughing and/or sneezing.

Like parts are marked throughout the drawing, as well as throughout the Detailed Disclosure, with the same reference characters. The figures are not necessarily drawn to scale and certain figures may be shown in exaggerated or generalized form in the interest of clarity and conciseness. Although specific features may be shown in some of the figures and not in others, this is for convenience only.

### DETAILED DESCRIPTION

The present disclosure is directed to a cough patch with germicidal and/or antimicrobial properties. Examples described herein include a body and a tab coupled to the body. The body has one or more germicidal and/or antimicrobial agents at a first face and one or more coupling mechanisms at a second face that is opposite the first face. The germicidal and/or antimicrobial agents facilitate killing one or more germs and/or pathogens while the coupling mechanisms facilitate securing the body to a user's clothing or skin. This enables droplets from coughing or sneezing to be contained in an efficient and/or effective manner. The following non-limiting examples are provided to further illustrate the present invention. As used herein, the term “germicidal” refers to destroying or inactivating one or more pathogens (e.g., bacteria, viruses, fungi), and the term “antimicrobial” refers to preventing or inhibiting the growth or spread of one or more pathogens.

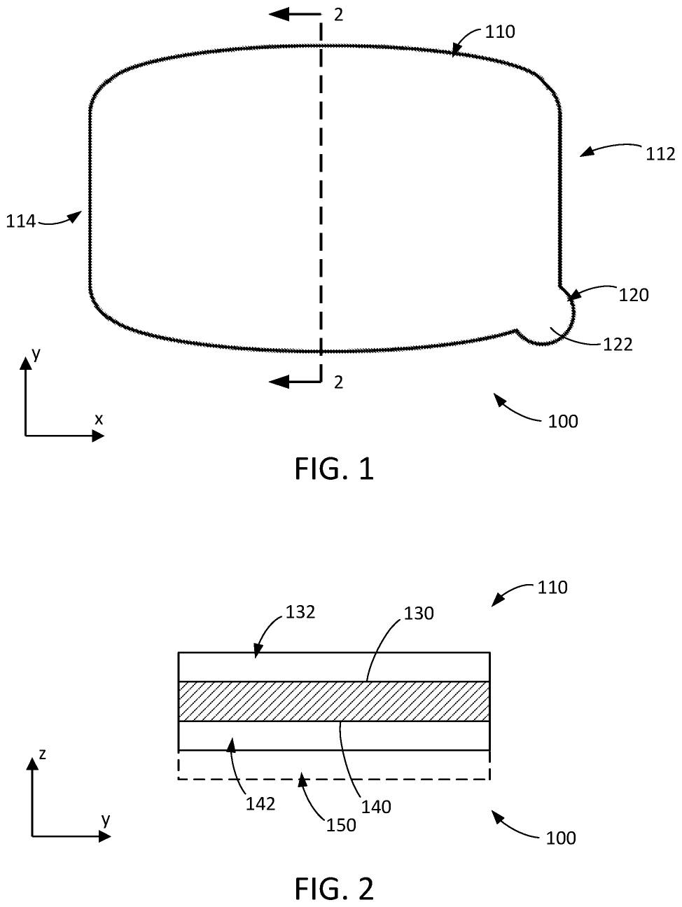

FIGS. 1 and 2 show a patch 100 including a body 110. The body 110 may be of any particular shape. In some examples, the body 110 is substantially planar or extends substantially in a plane (e.g., an X-Y plane). For example, as shown in FIG. 1, the body 110 may extend generally between a first end portion 112 and an opposing second end portion 114.

The patch 100 may include a tab 120 coupled to the body 110. For example, as shown in FIG. 1, the tab 120 may be substantially planar and/or extend from the body 110 in substantially the same plane as the body 110 (e.g., in the X-Y plane). In some examples, the tab 120 may extend from a corner at the first end portion 112 of the body 110. Alternatively, the tab 120 may extend from the body 110 in any other plane and/or direction that enables the patch 100 to function as described herein. The tab 120 may be of any particular shape. For example, as shown in FIG. 1, the tab 120 may include a circular sector portion 122.

The patch 100 may be fabricated from a flexible material, such a woven fabric and/or a nonwoven fabric. In some examples, the patch 100 includes a fabric that enables the patch 100 to absorb moisture. Additionally or alternatively, the patch 100 may include a fabric that enables the patch 100 to wick moisture. As shown in FIG. 2, the patch 100 and/or body 110 has a first face 130 (e.g., an outer surface). In some examples, the patch 100 includes one or more germicidal and/or antimicrobial agents 132 at the first face 130. The germicidal and/or antimicrobial agents 132 are configured to reduce a number of germs and/or pathogens. In some examples, the germicidal and/or antimicrobial agents 132 facilitate protecting the patch 100 from degradation and/or the user from infection. Example germicidal and/or antimicrobial agents 132 may include, for example, a copper material, a silver material, and/or a zinc material. As shown in FIG. 2, the germicidal and/or antimicrobial agents 132 may be coupled or applied to the first face 130 of the body 110 such that the germicidal and/or antimicrobial agents 132 overlie the body 110 in a plane extending above the first face 130 (e.g., toward a positive-Z direction). For example, the germicidal and/or antimicrobial agents 132 may be applied to the first face 130 of the body 110 using any known process including chemical vapor deposition (CVD), physical vapor deposition (PVD), spraying, ink jet material deposition, screen printing, gravure coating, dip-coating, and/or spin-coating. Additionally or alternatively, the germicidal and/or antimicrobial agents 132 may be integrated into or be an integral part of the body 110 (e.g., extend in the same plane as the body 110). For example, the germicidal and/or antimicrobial agents 132 may be embedded or infused into the fiber or filament of the body 110. In some examples, the germicidal and/or antimicrobial agents 132 may be added in particle form and/or as a liquid solution or suspension to a (non-cured) body 110 and subsequently cured therewith.

As shown in FIG. 2, the patch 100 and/or body 110 has a second face 140 (e.g., an inner surface) that is opposite the first face 130. In some examples, the patch 100 includes one or more coupling mechanisms 142 at the second face 140. The coupling mechanisms 142 are configured to couple the patch 100 to another object (e.g., a person's arm or sleeve). In some examples, the coupling mechanisms 142 may include an adhesive, a hook and loop fastener material, a tape, and/or a magnetic material. The coupling mechanisms 142 may be detachably adhereable, for example, to skin, clothing, and/or other material or object. In some examples, the coupling mechanisms 142 may be coupled or applied to the second face 140 of the body 110 such that the coupling mechanisms 142 “overlie” the body 110 in a plane extending below the second face 140 (e.g., toward a negative-Z direction). A force coupling the coupling mechanisms 142 to the body 110 is greater than a force with which the coupling mechanisms 142 are configured to couple the patch 100 to another object. The coupling mechanisms 142 may be coupled to the second face 140 of the body 110, for example, using a thermosetting polymer, a hot-melt adhesive, and/or a pressure-sensitive adhesive. Additionally or alternatively, the coupling mechanisms 142 may be integrated into or be an integral part of the body 110.

The tab 120 may include an outer surface (e.g., toward a positive-Z direction) and an inner surface (e.g., toward a negative-Z direction) that is opposite the outer surface. In some examples, the tab 120 may include one or more germicidal and/or antimicrobial agents 132 at the outer surface and/or inner surface of the tab 120. The inner surface of the tab 120 may be free from one or more coupling mechanisms 142. In this manner, the tab 120 may be used to handle or manipulate the patch 100 during application (e.g., when the patch 100 is being coupled to an individual's arm, sleeve, and/or other object) and/or removal (e.g., when the patch 100 is being uncoupled from the individual's arm, sleeve and/or other object).

In some examples, a peel sheet 150 may be extended in a plane below the coupling mechanisms 142 (e.g., toward a negative-Z direction) to facilitate shielding or protecting the coupling mechanisms 142 from the ambient environment prior to use. The peel sheet 150 may include one or more release agents configured to provide a release effect (e.g., for separating from the coupling mechanisms 142 in a manner that enables the coupling mechanisms 142 to retain their ability to couple the patch 100 to another object). For example, the peel sheet 150 may include a silicone-coated film or kraft paper. In some examples, a portion of the peel sheet 150 may extend laterally beyond the coupling mechanisms 142 (e.g., in the X-Y plane) such that the portion may be used to handle or manipulate the peel sheet 150 for removal from the patch 100 and/or coupling mechanisms 142.

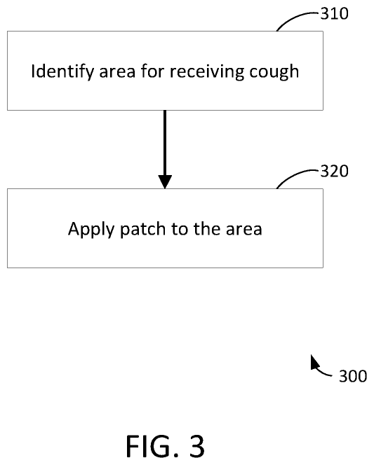

FIG. 3 shows a method 300 for preventing spread of germs from coughing and/or sneezing. The method 300 may be implemented using, for example, the patch 100. In some examples, an area is identified at operation 310 for receiving one or more coughs and/or sneezes. The area may be, for example, at a user's arm or elbow. In some examples, the area may include clothing. Alternatively, the area may include exposed skin.

The patch 100 may be applied to the area at operation 320. In some examples, a peel sheet 150 coupled to the body 110 at the second face 140 may be removed from the patch 100 and/or one or more coupling mechanisms 142 to expose one or more coupling mechanisms 142 prior to applying the patch 100 at operation 320. The coupling mechanisms 142 facilitate coupling the patch 100 to the area such that the antimicrobial agents 132 at the first face 130 are open or exposed to the ambient environment and/or accessible to the user (e.g., for receiving a cough or sneeze). In this manner, the user may cough or sneeze into or onto the first face 130 of the patch 100, where the antimicrobial agents 132 may eliminate or reduce the number of germs, thereby reducing the spread of germs, pathogens, and/or disease. In some examples, the patch 100 may be used for a period of time and then uncoupled or removed from the area (e.g., for disposal). For example, the user may grasp or manipulate the tab 120 and apply a peeling force to uncouple or remove the patch 100 from the user's arm or elbow. The tab 120 enables the user to handle the patch 100 without having the touch the body 110.

This written description uses examples to disclose aspects of the disclosure and also to enable a person skilled in the art to practice the aspects, including making or using the above-described systems and executing or performing the above-described methods. The example patches described herein provide easy access to germicidal and/or antimicrobial agents for use in killing one or more germs and/or pathogens. In this manner, droplets from coughing or sneezing may be contained, thereby mitigating contamination of a person's clothing and/or skin.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a figure may be referenced and/or claimed in combination with any feature of any other figure.

When introducing elements of the present disclosure, the articles “a”, “an”, “the” and “said” are intended to mean that there are one or more of the elements. References to an “embodiment” or an “example” of the present disclosure are not intended to be interpreted as excluding the existence of additional embodiments or examples that also incorporate the recited features. The terms “comprising”, “including” and “having” are intended to be inclusive and mean that there may be additional elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A patch for use in receiving one or more coughs, said patch comprising:
a body extending substantially in a body plane, the body having a first face and a second face opposite the first face;
one or more germicidal agents at the first face;
one or more coupling mechanisms at the second face; and
a tab coupled to the body, the tab extending substantially in the body plane.

2. The patch of claim 1, wherein the one or more germicidal agents are coupled to the body at the first face.

3. The patch of claim 1, wherein the one or more germicidal agents extend substantially in the body plane.

4. The patch of claim 1, wherein the one or more germicidal agents extend substantially in a germicidal plane above the body plane.

5. The patch of claim 1, wherein the one or more germicidal agents are coupled to the tab.

6. The patch of claim 1, wherein the one or more coupling mechanisms are coupled to the body at the second face.

7. The patch of claim 1, wherein the one or more coupling mechanisms extend substantially in the body plane.

8. The patch of claim 1, wherein the one or more coupling mechanisms extend substantially in a coupling plane below the body plane.

9. The patch of claim 1, wherein the tab is free from the one or more coupling mechanisms.

10. The patch of claim 1, wherein the tab includes a circular sector portion.

11. A system for use in receiving one or more coughs, said system comprising:
a body extending substantially in a body plane, the body having one or more germicidal agents at a first face and one or more coupling mechanisms at a second face opposite the first face; and
a tab coupled to the body, the tab extending substantially in the body plane.

12. The system of claim 11, wherein the one or more germicidal agents are coupled to the tab.

13. The system of claim 11, wherein the tab is free from the one or more coupling mechanisms.

14. The system of claim 11, wherein the tab includes a circular sector portion.

15. The system of claim 11, further comprising a peel sheet coupled to the body at the second face.

16. The system of claim 11, further comprising a peel sheet extending in a sheet plane below the body plane.

17. A method for preventing spread of germs from coughing, the method comprising:
identifying an area for receiving one or more coughs;
applying a patch to the area, the patch including a body extending substantially in a body plane, the body having one or more germicidal agents at a first face and one or more coupling mechanisms at a second face opposite the first face, and a tab coupled to the body, the tab extending substantially in the body plane.

18. The method as recited in claim 17, further comprising removing a peel sheet from the one or more coupling mechanisms.

19. The method as recited in claim 17, further comprising removing the patch from the area.

20. The method as recited in claim 17, further comprising manipulating the tab to remove the patch from the area.
